(19) United States
(12) Patent Application Publication
(10) Pub. No.: US 2006/0282230 A1
(43) Pub. Date: Dec. 14, 2006

(54) Security device for a sensor

(76) Inventors: Heinz-Werner Morrell, Kaiserslautern (DE); Dietmar Schmid, Villmar (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/562,743

(22) PCT Filed: Jun. 1, 2004
(86) PCT No.: PCT/EP04/50977

§ 371 Date: May 1, 2006

(30) Foreign Application Priority Data
Jun. 30, 2003 (DE) 103 29 511.9

(51) Int. Cl. G01C 25/00

(52) U.S. Cl. 702/116

(57) ABSTRACT

The invention relates to a security device for a sensor, especially a rotational speed sensor, wherein a sensor element and functional components enable the sensor to function and produce a sensor output signal. Said functional components form a functional section. Control components are provided in a control section and monitoring components are provided in a monitoring section. The control components are embodied in such a manner that they can control the functional components in a continuous manner and the monitoring components are embodied such that they can monitor the control components at least once during the a working cycle.

The invention relates to a safety device for a sensor, in particular a rotation rate sensor, in which a sensor element and functional components provide the function of the sensor, and produce a sensor output signal.

By way of example, rotation rate sensors have been disclosed in EP 0 461 761 B1 in which a vibration gyro is excited on two radially directed axes, for which purpose a primary and a secondary control loop, with appropriate transducers, are provided on the vibration gyro. When such rotation rate sensors are used in order to stabilize the vehicle movement in vehicles, then hazards can occur as a result of failure or a malfunction. In order to avoid this, functional monitoring must be provided for the rotation rate sensor.

In the case of the safety device according to the invention, such monitoring can be carried out by the functional components forming a function section and, furthermore, by checking components being provided in a checking section and by monitoring components being provided in a monitoring section, with the checking components being designed for continuous checking of the functional components, and with the monitoring components being designed to monitor the checking components at least once during one operating cycle.

One advantage of the safety device according to the invention is that the continuous monitoring allows rapid fault reports, which signal a fault, and thus the possibly incorrect sensor output signal, to the user and to higher-level systems. This rapid reaction is supplemented by monitoring of the checking section, so that faults are also signaled which, although they do not lead directly to an incorrect sensor output signal, can lead to hazards when a second fault occurs however. Functional component redundancy is required to only a minor extent for this purpose.

One advantageous refinement provides that the checking components are designed to measure values in the function section and to compare the measured values with limit values. In this case, the checking components are furthermore preferably designed to measure the sensor output signal and to compare the measured sensor output signal with limit values.

Even better checking is made possible by a development of this refinement, which consists in that the checking components are furthermore designed to test the functional components, with test signals being produced and being supplied to the functional components, and the reaction of the functional components to the test signals being measured.

If the sensors are relatively complex, the function section contains digital and analog components, for which purpose provision is made in the device according to the invention for the checking components to be designed to access registers of the digital components and to measure analog signals at the analog components. In order to further extend the checking capabilities, provision can be made in this case for the checking section to contain its own analog components and at least one analog/digital converter.

Another advantageous requirement of the invention consists in that the monitoring components are designed essentially to monitor digital checking components. In this case, in detail, it is possible to provide for the monitoring section to have a component for monitoring the clock of a microcomputer which is contained in the checking section, and/or for the monitoring section to have a watchdog circuit for monitoring a microcomputer which is contained in the checking section. Furthermore, this refinement can be designed in such a way that the monitoring section contains a device for testing memories within the checking section.

Electronic circuits, including programmable devices, are frequently formed by application-specific integrated circuits, ASIC for short. These have a very large number of gate circuits which are frequently used in the duplicated form when the respective signal flow and the linking logic allow. In order not to endanger the high degree of safety achieved by the safety device according to the invention, one development of the invention provides that components in the function section, in the checking section and in the monitoring section be formed by an application-specific integrated circuit (ASIC), and that gate circuits which are contained in the circuit be in each case associated with only one of the sections.

The invention allows numerous embodiments. One of these will be described in the following text and is illustrated schematically in a number of figures in the drawing, in which:

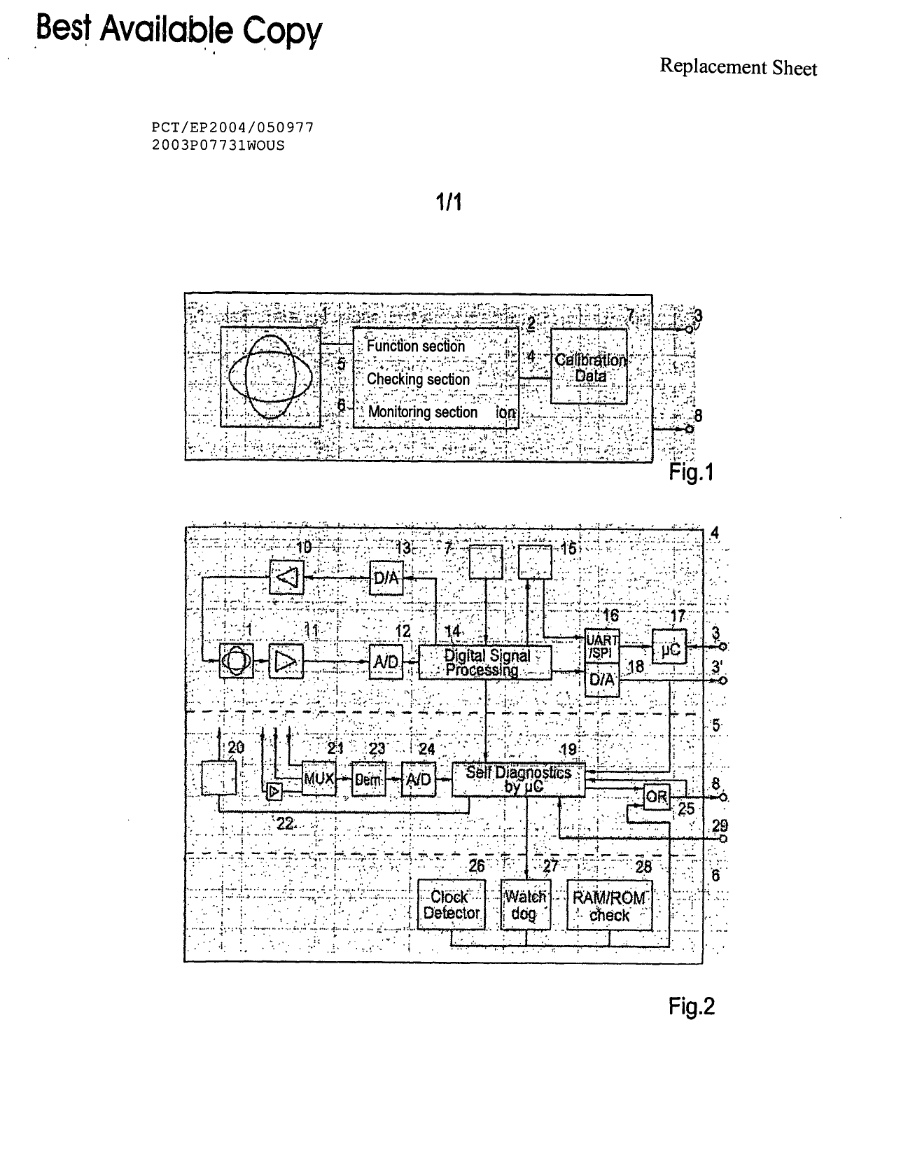

FIG. 1 shows a schematic illustration of the various sections, and

FIG. 2 shows a block diagram of a device according to the invention, using the example of a rotation rate sensor.

The exemplary embodiment and parts of it are admittedly illustrated as block diagrams. However, this does not mean that the arrangement according to the invention is restricted to an implementation based on individual circuits corresponding to the blocks. In fact, the arrangement according to the invention can be implemented in a particularly advantageous manner by means of large-scale-integrated circuits. In this case, microprocessors can be used which carry out the processing steps illustrated in the block diagrams when suitably programmed. For the purposes of the invention, the expression components should be understood as meaning circuits, computers, memories and similar hardware, including the associated programs and program modules.

The schematic illustration shown in FIG. 1 shows a vibration gyro 1, for whose operation circuits 2 are provided. In this case, one section of these circuits is provided for the actual operation of the vibration gyro 1 and for production of a rotation rate signal, which is produced at an output 3. This section is referred to in the following text as the function section 4. Further circuits, which are combined to form a checking section 5, are used for continuous monitoring. Finally, these are monitored by a monitoring section 6. A non-volatile memory 7 is used to store adjustment data. A further output 8 is provided, for outputting an alarm signal.

Components of the sections 4, 5, 6 are illustrated in somewhat more detail in the block diagram in FIG. 2. Thus, for example, two amplifiers 10, 11, an analog/digital converter 12 and a digital/analog converter 13 are provided for operation of the vibration gyro 1. Further components, for example filters, are not required for understanding of the invention and are therefore not illustrated and explained in any more detail. The signals which are tapped off from the vibration gyro 1, are amplified at 11 and are digitized at 12 are processed in digital form at 14, resulting in a driver signal which is supplied via the digital/analog converter 13 and the amplifier 10 to one input of the vibration gyro.

On being switched on, adjustment data is loaded from the non-volatile memory 7. Data which includes the rotation rate signal is taken via a microcomputer 15 from the digital signal processing 14, and is supplied via a UART/SPI interface 16 to a further microcomputer 17.

This produces a digital rotation rate signal at the output 3. In parallel with this, a digital/analog converter 18 is connected to the digital signal processing 14, and an analog rotation rate signal is produced at its output 3′.

The checking section is formed essentially by self-diagnosis 19 by the microcomputer, with data being made available to the digital signal processing 14. Furthermore, in order to test analog components in the function section, the checking section has a test signal injector 20 which can be controlled by the self-diagnosis 19 and can supply analog test signals at selectable points to the analog circuits in the function section. A plurality of points in the analog circuits in the function section 4 are connected to a multiplexer 21, so that a selectable analog signal can be checked.

An amplifier 22 is provided for situations in which one of these analog signals has a relatively small amplitude. In the exemplary embodiment, the analog signals to be checked are at a carrier frequency. The multiplexer 21 is therefore followed by a demodulator 23. After analog/digital conversion 24, the self-diagnosis 19 can access the analog signals to be checked. The self-diagnosis 19 receives the analog output signal from the output 3′ and the alarm signal from the output 8 for further testing. If the self-diagnosis 19 finds a fault, an alarm signal is emitted via the OR circuit 25 and the output 8. The alarm signal also takes place via a status bit in the serial data message at the UART/SPI interface.

The monitoring of the program execution in the microcomputer, and of the presence of a clock signal and correct operation of the memories are carried out in the monitoring section 6 with the aid of a clock detector 26, a watchdog 27 and a RAM/ROM test 28. If one of these components finds a fault,an alarm signal is emitted via the OR circuit 25 and the output 8. A self-diagnosis process can be started via an input 29, for example during maintenance work or during a pause in operation of the vehicle.

1.-11. (canceled)

12. A safety device for a rotation rate sensor, comprising a sensor element and circuits including a function section, a checking section and a monitoring section, the function section including functional components supporting the function of the sensor and producing a sensor output signal, the checking section including checking components designed for the continuous checking of the functional components, and the monitoring section comprising monitoring components designed for monitoring the checking components at least once during one operating cycle, the monitoring components comprising a clock detector component monitoring a clock of a microcomputer contained in the checking section, a watchdog circuit monitoring the microcomputer and a memory testing device for testing memories within the checking section.

13. The device of claim 12, wherein the checking components measure values in the function section and compare the measured values with limit values.

14. The device of claim 13, wherein the checking components measure the sensor output signal and to compare the measured sensor output signal with limit values.

15. The device of claim 13, wherein the checking components comprise a test injector producing and supplying test signals to the functional components, the checking components testing the functional components and measuring a reaction of the functional components to the test signals.

16. The device of claim 13, wherein the function section comprises digital components and analog components, the checking components accessing registers of the digital components and measuring analog signals at the analog components.

17. The device of claim 16, wherein the checking section includes checking analog components and at least one analog/digital converter.

18. The device of claim 12, wherein the monitoring components are designed essentially to monitor digital checking components.

19. The device of claim 12, wherein components in the function section, the checking section, and the monitoring section are formed by an application-specific integrated circuit (ASIC) comprising gate circuits, and wherein each of the gate circuits in the application-specific integrated circuit is associated with only one of the function section, the checking section, and the monitoring section.
